(19) United States
(12) Patent Application Publication
(10) Pub. No.: US 2014/0123553 A1
(43) Pub. Date: May 8, 2014

(54) GARDEN SHELTER

(71) Applicant: MOSPEN PRODUCTS COMPANY, Taipei (TW)

(72) Inventor: CHASON YEN, TAIPEI (TW)

(73) Assignee: MOSPEN PRODUCTS COMPANY, TAIPEI (TW)

(21) Appl. No.: 13/669,406

(22) Filed: Nov. 5, 2012

(51) Int. Cl. A01G 1/00

(52) U.S. Cl. 47/33

(57) ABSTRACT

A garden shelter comprises a housing body and a plurality of fastening portions. The housing body is formed with a first section and a second section from the top down, and whose intersection between the first and second sections is formed with a plurality of fastening portions, wherein a height of the first section is H₁, and a height of the second section is H₂. One end of each fastening component is disposed with a pressing ring corresponding to the fastening portions while another end is a rod body. The length of the rod body is L, and 0.15 (H₁+H₂)<L<0.3 (H₁+H₂). The housing body is mounted on a ground through the fastening components. The rod body must go deep into an effective depth D, and 0.75 L<D<0.99 L. The garden shelter is provided for encapsulating a water faucet or a fire hydrant.

### BACKGROUND OF THE INVENTION

1. Field of the Invention

The invention relates falls under the technical field of garden landscaping, and more particularly describes a garden shelter conveniently fastened on the ground to shelter articles already on the ground.

2. Description of Related Technology

To arrange a garden, different kinds of trees or flowers are usually planted, and a water supply well or a water faucet is installed to facilitate irrigation. Fire hydrant is even installed for fire safety reasons, and while the fire hydrant is usually located at a humble position in the garden, it still destroyed the garden's beauty. Further, the aforementioned devices may cause potential dangers in the garden. The water supply well, for its part, is usually equipped with a well cover. The well cover not only satisfies the beauty requirement but also safeguards the well from foreign bodies. These well covers are produced into different types. For convenience's sake, the well also cover must contain features that allow for easy removal.

The water faucet or fire hydrant, on the other hand, usually protrudes from the ground. These devices may not be covered or protected by a well cover. U.S. Pat. No. 6,131,654, entitled “Well cover and method of making” outlines a solution. In FIG. 1 and FIG. 2, structural schematic diagrams of a conventional well cover are depicted. As shown in the figures, the well cover 1 comprises a case 11 and a plurality of fastening anchors 12. The case 11 comprises an upper outline surface 111 and a lower surface 112 as a recess, an external periphery base portion 113 between the upper outline surface 111 and the lower surface 112, and at least one connection structure 114 installed on the external periphery base portion 113. The fastening anchors 12 are used for connecting and fastening the connection structure 114 on the ground, wherein the connection structure 114 is a ring flange having many holes or grooves or a convex strip having holes or grooves. Thus, the fastening anchors 12 have sufficient depth to go into ground and firmly anchor well cover 1 by piercing through the connection structure. Moreover, each fastening anchor 12 is further equipped with handle 121 to insert into or remove the fastening anchor 12 from the ground.

Although the well cover 1 can be conveniently mounted or detached by a user, the foregoing design may not satisfy the beauty requirement. After mounting, for example, the connection structures 114 remain on the ground. To meet the beauty requirement, the structure is has to be hidden by burying it under soil or leaves. The connection structure 114 may be corroded and damaged as a result, and the fastening effect may also be affected. Further, if the structure is buried for a while, the thickness of periphery soil layers is also increased. Consequently, it may be difficult to find the original mounting position of fastening anchors 12, causing serious inconvenience. A solution is required.

### SUMMARY OF THE INVENTION

In view of the shortcomings prior technologies, the developers of the present invention conducted extensive research and experiments based on years of experience in the industry, and finally developed a garden shelter with the ability to be mounted and detached as its principle innovation. The garden shelter is mounted on the ground to encapsulate different kinds of articles protruding from ground, such as a water faucet or a fire hydrant. The garden shelter comprises a housing body which can encapsulate various articles, and whose the exterior of the housing body is made to simulate stones or earth hummock. The housing body formed by a first section and a second section from the top down, and an intersection between the first section and the second section equipped with a plurality of fastening portions, wherein a specific value of a height H₁ of the first section and a height H₂ of the second section is between 1 to 100. A plurality of fastening components, one end of each such fastening component is equipped with a pressing ring corresponding to the fastening portions while another end is a rod body passing through each fastening portion and going deep into the ground, wherein a length L of the rod body is 0.15 (H₁+H₂)<L<0.3 (H₁+H₂), and the rod body goes deep into the ground to reach an effective depth D while fastening, where 0.75 L<D<0.99 L.

The setting includes an angle θ, the angle between the plurality of fastening components and the ground, where 45°≦θ90°.

The fastening portions are formed into a recess structure for installing the plurality of pressing rings.

In an embodiment, the garden shelter of the invention further has a plurality of plug pillars. The plug pillars are inserted into the openings of the fastening portions respectively to seal the fastening portions. They are made of a flexible material. This system not only have aesthetic appeal, it can also be detached or assembled to prevent the fastening portions from being intruded by foreign matters or water while using the plug pillars without influencing the service life of the fastening components.

To achieve a second objective of the invention, a garden shelter that can be utilized without detachment or assembly is provided such that the first section is produced into a cover structure body, and the second section is formed with a tubular structure body. The first section covers an upper opening of the second section to allow the housing body to form a sealed state such that a user merely separates the first section from the second section, and the articles located inside the housing body can be used.

Below, two specific structural designs are provided. First, the housing body further has a connection portion and a lock, wherein the connection portion and the lock are symmetrically disposed and respectively connected between the first section and the second section. Secondly, the housing body is provided with a plurality of connection portions. The connection portions are spaced at intervals and connected between the first section and the second section.

### BRIEF DESCRIPTION OF THE DRAWINGS

FIG. 1 is a structural schematic diagram (I) of a conventional well cap;

FIG. 2 is a structural schematic diagram (II) of a conventional well cap;

FIG. 3 is a structural schematic diagram according to a preferred embodiment of the invention;

FIG. 4 is a schematic diagram of a state of the structure mounted on the ground according to a preferred embodiment of the invention;

FIG. 5 is another implementation (I) according to a preferred embodiment of the invention;

FIG. 6 is another implementation (II) according to a preferred embodiment of the invention.

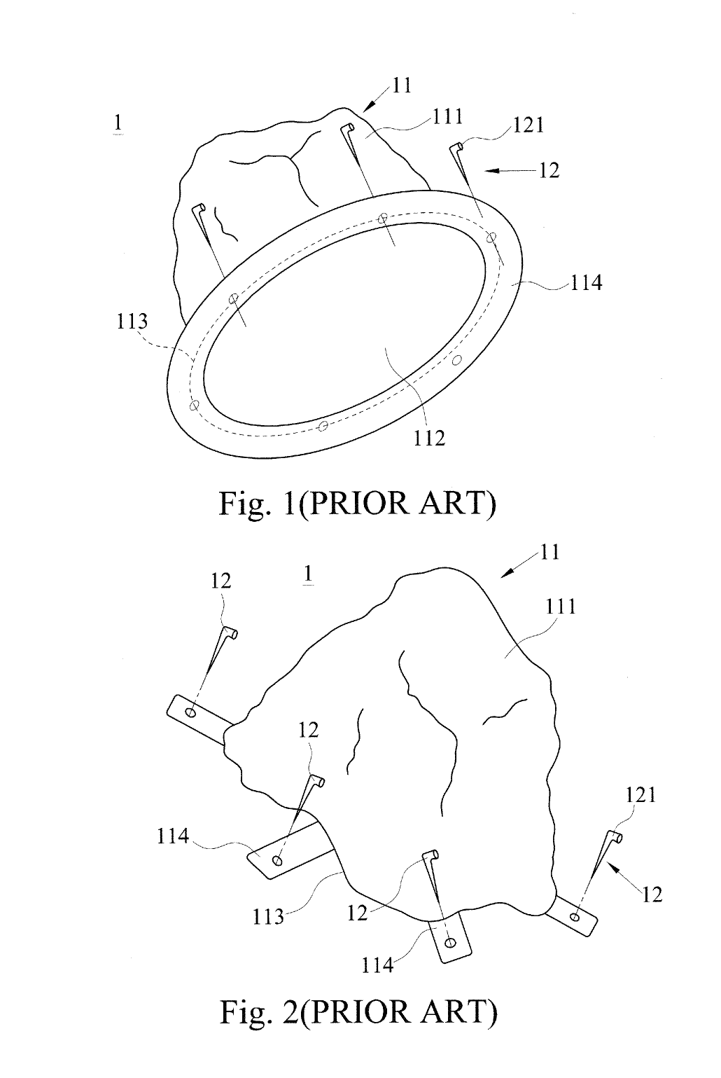

### DETAILED DESCRIPTION OF THE PREFERRED EMBODIMENTS

The technical content of the present invention will become apparent by the detailed description of the following embodiments and the illustration of related drawings.

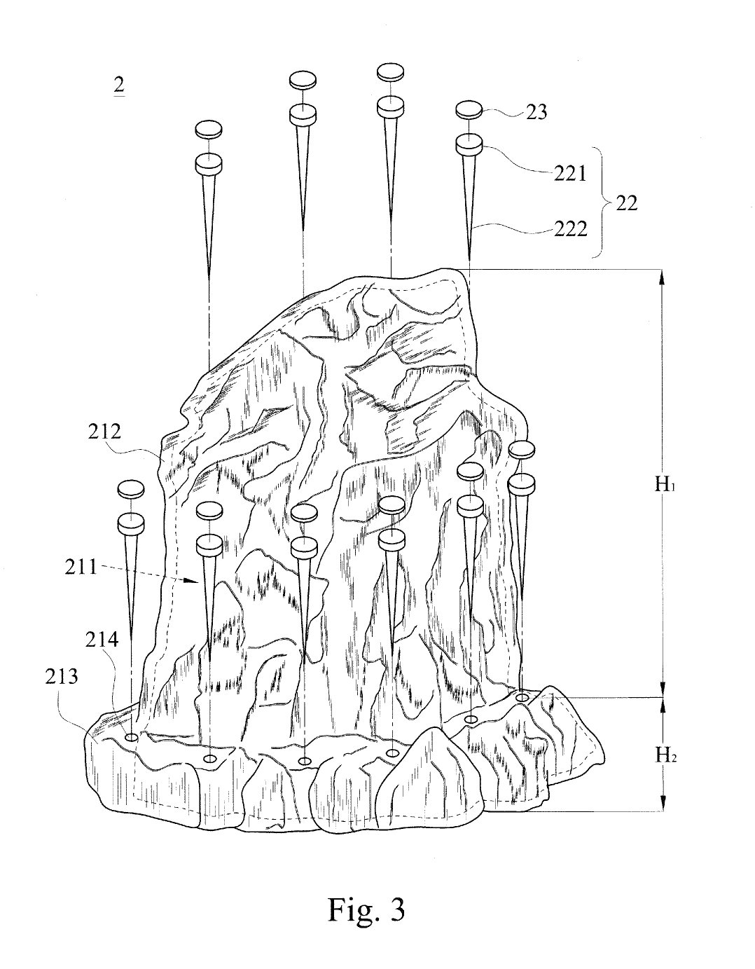

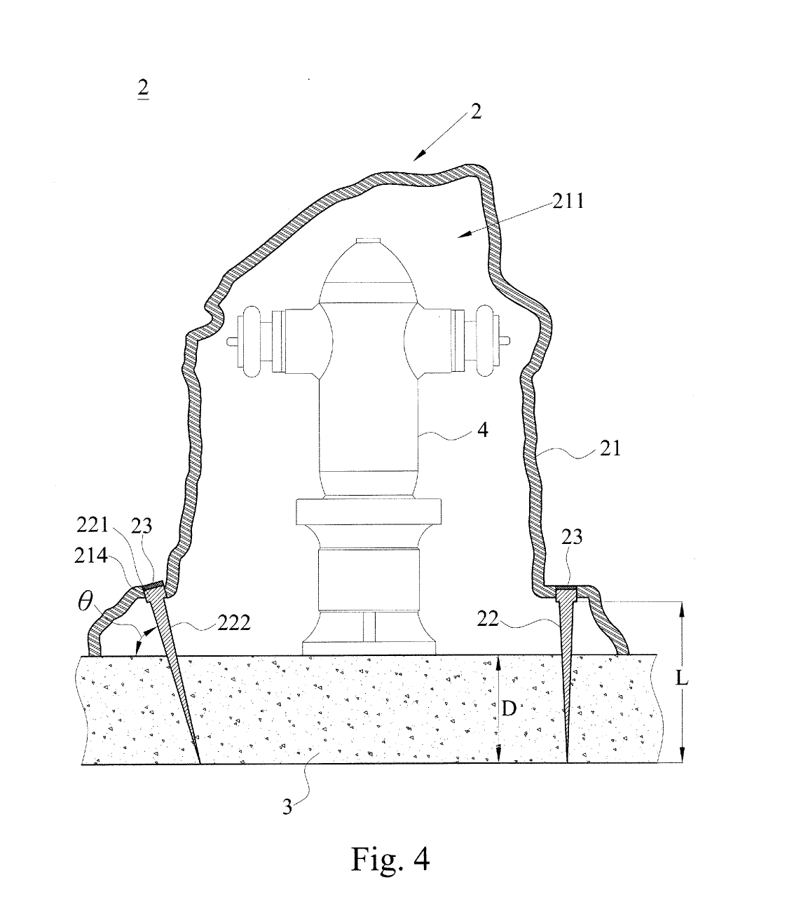

FIG. 3 and FIG. 4 respectively depict an abstract schematic diagram of the structure and a schematic diagram of the structure mounted on the ground according to a preferred embodiment. As shown in the figures, garden shelter 2 of the invention is mounted on a ground 3 to encapsulate an article 4, such as a water faucet or a fire hydrant, protruding from ground 3. The garden shelter 2 comprises a housing body 21 and a plurality of fastening components 22.

The housing body 21 is made of plastic materials. The inside of the housing body 21 is formed with a containing space 211 to encapsulate the article 4, and the exterior of the housing body 21 is made to simulate stone or earth hummock. The housing body 21 is formed with a first section 212 and a second section 213 from the top down. The intersection between the first section 212 and the second section 213 is equipped with a plurality of fastening portions 214, wherein the specific value of the height H₁ of the first section 212 and the height H₂ of the second section 213 is between 1 and 100.

One end of each fastening component 22 is disposed with a pressing ring 221 corresponding to the fastening portions 214 while another end is a rod body 222 passing through each fastening portion 22 and going deep into the ground 3. The length L of the rod body 222 can be 1.5 H₂<L2<(H₁+H₂). While fastened, the rod body 22 must go deep into the ground 3 to reach an effective depth D such that the housing body 211 is fastened on the ground 3 without toppling over. After testing on the spot, the effective depth D must be at a 0.75 to 0.99 multiple of the total length of the rod body 222. It should be noted that one setting imagines an angle of θ (where 45°≦θ≦90° between the fastening components 22 and the ground 3. In another, the fastening components are directly inserted into the ground perpendicular to the ground 3 or inserted into the ground at a 45° to 89° oblique angle.

In addition, the fastening portions 214 are formed into a recess structure for placing the pressing rings 221 to integrate with the housing body 21 so that the fastening components 22 can be utilized to fasten the housing body 21 on the ground 3. It should be noted that the invention provides a plurality of plug pillars 23 made of a flexible material in order to prevent the fastening portions 214 from being intruded by water or dust. The plug pillars 23 are each inserted into the opening place of the fastening portions 214 to seal the fastening portions 214.

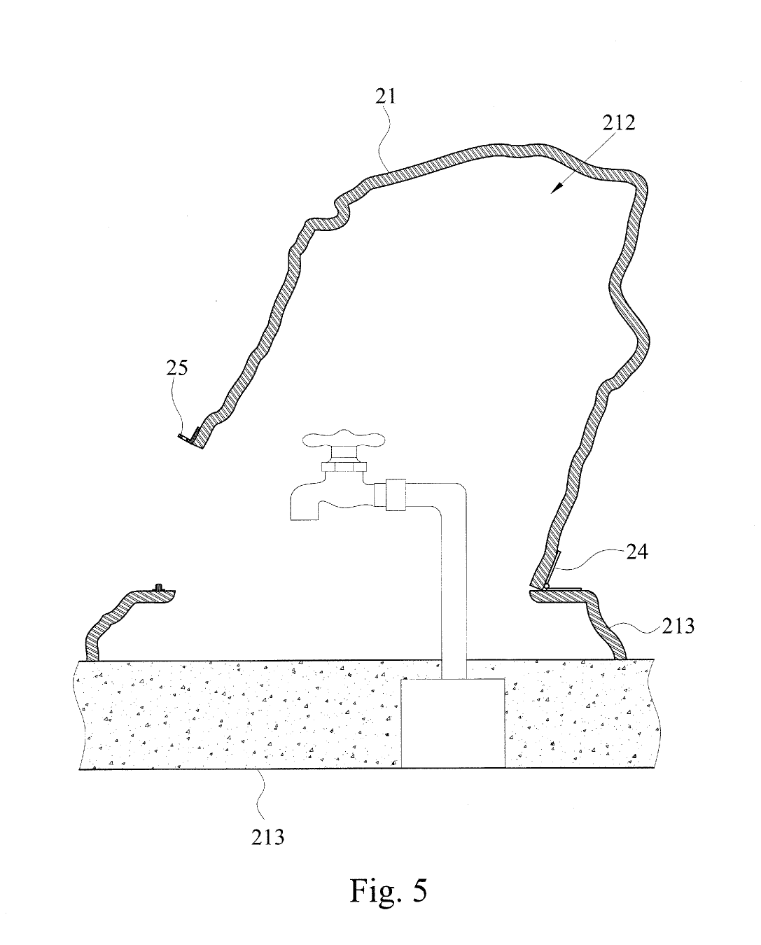

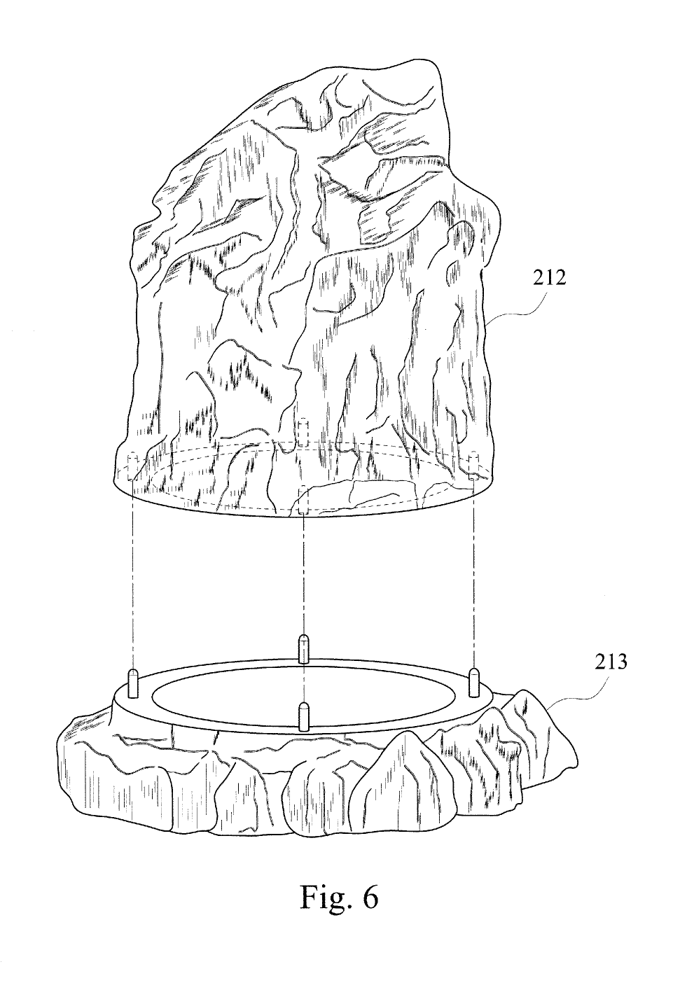

In FIG. 5 and FIG. 6, other implementations according to a preferred embodiment of the invention are depicted. As shown in the figures, the first section 212 of the housing body 21 is produced into a cap structure body, and the second section 213 is formed into a tubular structure body. Since the first section 212 can cover the upper opening of section 213 to allow the housing body 21 to form a sealed state and thereby enclose article 4 (no numeric shown in the figure). As shown in FIG. 5, to conveniently access article 4, the inventor specifically designs a connection portion 24 and a lock 25. The connection portion 24 and the lock 25 are respectively connected between the first section 212 and the second section 213. The connection portion 24 and the lock 25 are symmetrically installed. As shown in FIG. 6, the first section 212 and/or the second section 213 is equipped with a plurality of connection portions 24. The connection portions 24 are spaced at intervals and respectively connected between the first section 212 and the second section 213. By utilizing buckle or insertion mechanisms, the first section 212 is sealed above the second section 213. Not only can the foregoing two structural designs be implemented, but the user can also access the article without detaching the housing body 21.

While the means of specific embodiments in the present invention has been described by reference drawings, numerous modifications and variations could be made thereto by those skilled in the art without departing from the scope and spirit of the invention set forth in the claims. The modifications and variations should limited in range by the specification of the present invention.

What is being claimed:

1. A garden shelter mounted on a ground to encapsulate different kinds of articles protruding from ground, such as a water faucet or a fire hydrant, and the garden shelter comprises:
a housing body formed with a containing space inside to encapsulate the articles, and whose exterior is made to simulate stones or earth hummock, while the housing body formed by a first section and a second section from the top down, an intersection between the first section and the second section disposed with a plurality of fastening portions, wherein a specific value of a height H₁ of the first section and a height H₂ of the second section is between 1 to 100;
a plurality of fastening components, one end of each fastening component disposed with a pressing ring corresponding to the fastening portions while another end of each fastening portion is a rod body passing through each fastening portion to go deep into the ground, a length L of the rod body being 0.15 (H₁+H₂)<L<0.3 (H₁+H₂), the rod body going deep into the ground to reach an effective depth D while fastened, where 0.75 L<D<0.99 L.

2. The garden shelter of claim 1, wherein a setting of angle θ is between the plurality of fastening components and the ground, and 45°≦θ≦90°.

3. The garden shelter of claim 1, wherein the plurality of fastening portions are formed into a recess structure for installing the plurality of pressing rings.

4. The garden shelter of claim 3, further comprising a plurality of plug pillars, wherein the plurality of plug pillars are inserted into openings of the fastening portions respectively to seal the fastening portions.

5. The garden shelter of claim 4, wherein the plug pillars are made of a flexible material.

6. The garden shelter of claim 1, wherein the first section is produced into a cap structure body and the second section is formed into a tubular structure body, and the first section covers an upper opening of the second section to allow the housing body to form a sealed state.

7. The garden shelter of claim 6, further comprising a connection portion and a lock, wherein the connection portion and the lock are symmetrically installed and connected between the first section and the second section.

8. The garden shelter of claim 6, further comprising a plurality of connection portions, wherein the plurality of connection portions are spaced at intervals and connect the first section and the second section.
